(19) United States
(12) Patent Application Publication
(10) Pub. No.: US 2025/0301422 A1
(43) Pub. Date: Sep. 25, 2025

(54) POWER REDUCTION FOR SIGNAL TRANSMISSION

(71) Applicant: Lenovo (Singapore) Pte. Limited, Singapore (SG)

(72) Inventor: Colin Frank, Park Ridge, IL (US)

(73) Assignee: Lenovo (Singapore) Pte. Limited, Singapore (SG)

(21) Appl. No.: 18/863,050

(22) PCT Filed: May 1, 2023
(86) PCT No.: PCT/IB2023/054519

§ 371 Date: Nov. 5, 2024

Related U.S. Application Data
(60) Provisional application No. 63/339,305, filed on May 6, 2022.
(60) Provisional application No. 63/339,314, filed on May 6, 2022.

(51) Int. Cl. H04W 52/36

(52) U.S. Cl. CPC H04W 52/367

(57) ABSTRACT

Various aspects of the present disclosure relate to a user equipment (UE) that controls aspects of power reduction for signal transmission to reduce an amount of power reduction that is applied as part of compliance with user safety parameters. For instance, power class reduction algorithms are disclosed that provide minimum power class reductions for different power classes while enabling compliance with specified user safety parameters. Further, the described techniques enable appropriate maximum power reduction (MPR) or additional maximum power reduction (A-MPR) values to be identified and applied in conjunction with power reduction.

### RELATED APPLICATIONS

This application claims priority to U.S. patent application Ser. No. 63/339,305 filed 6 May 2022 entitled “POWER REDUCTION FOR SIGNAL TRANSMISSION,” and U.S. patent application Ser. No. 63/339,314 filed 6 May 2022 entitled “POWER REDUCTION FOR SIGNAL TRANSMISSION,” the disclosures of which are hereby incorporated by reference herein in their entirety.

### TECHNICAL FIELD

The present disclosure relates to wireless communications, and more specifically to power management in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

For wireless communications, safety parameters have been defined to increase user safety for UE users. For instance, specific absorption rate (SAR) and maximum permissible exposure (MPE) limits have been defined that apply to UE operation. Transmit operation (e.g., transmit power and/or transmit scheduling) of UEs, for example, can be controlled to enable UE compliance with specified safety parameters.

### SUMMARY

The present disclosure relates to methods, apparatuses, and systems that support power reduction for signal transmission. By utilizing the described techniques, an amount of power reduction that is applied as part of compliance with user safety parameters is reduced, such as for compliance with regulatory parameters for SAR, MPE, and so forth. For instance, an amount of power reduction that is applied is reduced for signal transmission by a UE over single carrier frequencies which can provide higher signal quality and increased device (e.g., UE) performance.

Some implementations of the method and apparatuses described herein may include wireless communication at a device (e.g., a UE), and the device detects a condition to adjust a power class reduction for a single carrier transmission; and adjusts the power class reduction for the single carrier transmission based on a measured duty cycle and a maximum duty cycle.

In some implementations of the method and apparatuses described herein, the device adjusts the power class reduction for single carrier transmission based on a ratio of the measured duty cycle and the maximum duty cycle; based at least in part on adjustment of the power class reduction for single carrier transmission, adjusts an upper bound of a transmitter power; based at least in part on adjustment of the power class reduction for single carrier transmission, adjusts a lower bound of a transmitter power; where to adjust the power class reduction, the device reduces the power class reduction for single carrier transmission based on the measured duty cycle and the maximum duty cycle; where the measured duty cycle includes a percentage of symbols transmitted by the UE over an evaluation period; the device determines a value for the maximum duty cycle based on a power class of the UE; determines that an adjusted power class does not correspond to a power class for which maximum power reduction (MPR) or additional maximum power reduction (A-MPR) is defined; and utilizes an MPR or A-MPR for a next higher power class for which MPR or A-MPR is defined for single carrier transmission by the UE.

Some implementations of the method and apparatuses described herein may include wireless communication at a device (e.g., a UE), and the device detects a condition to adjust a power class reduction for single carrier transmission; and adjusts the power class reduction for the single carrier transmission based on a measured duty cycle and a defined maximum power class duty cycle.

In some implementations of the method and apparatuses described herein, the device adjusts the power class reduction for single carrier transmission based on a ratio of the measured duty cycle and the defined maximum power class duty cycle; based at least in part on adjustment of the power class reduction for single carrier transmission, adjusts an upper bound of a transmitter power; based at least in part on adjustment of the power class reduction for single carrier transmission, adjusts a lower bound of a transmitter power; reduces the power class reduction for single carrier transmission based on the measured duty cycle and the defined maximum power class duty cycle; where the measured duty cycle includes a percentage of symbols transmitted by the UE over an evaluation period; where the defined maximum power class duty cycle includes a defined maximum power class duty cycle defined base on one or more of a UE type or a UE power class; the device determines that an adjusted power class does not correspond to a power class for which MPR or A-MPR is defined; and utilizes an MPR or A-MPR for a next higher power class for which MPR or A-MPR is defined for single carrier transmission by the UE.

Some implementations of the method and apparatuses described herein may include wireless communication at a device (e.g., a UE), and the device detects a condition to adjust a power class reduction for single carrier transmission; adjusts the power class reduction for the single carrier transmission based on one or more of a measured duty cycle and a maximum duty cycle, or a measured duty cycle and a defined maximum power class duty cycle; determines that an adjusted power class does not correspond to a power class for which MPR or A-MPR is defined; and utilizes an MPR or A-MPR for a next higher power class for which MPR or A-MPR is defined for single carrier transmission by the UE

In some implementations of the method and apparatuses described herein, the device adjusts the power class reduction for single carrier transmission based on one or more of: a ratio of the measured duty cycle and the maximum duty cycle; or a ratio of the measured duty cycle and the defined maximum power class duty cycle; based at least in part on adjustment of the power class reduction for single carrier transmission, adjusts a bound of a transmitter power, and where the bound on the transmitter power is one or more of: an upper bound on the transmitter power; or a lower bound on the transmitter power; where the measured duty cycle includes a percentage of symbols transmitted by the UE over an evaluation period.

### BRIEF DESCRIPTION OF THE DRAWINGS

Various aspects of the present disclosure for power reduction for signal transmission are described with reference to the following Figures. The same numbers may be used throughout to reference like features and components shown in the Figures.

FIG. 1 illustrates an example of a wireless communications system that supports power reduction for signal transmission in accordance with aspects of the present disclosure.

FIG. 2 illustrates an example block diagram of components of a device (e.g., a UE) that supports power reduction for signal transmission in accordance with aspects of the present disclosure.

FIG. 3 illustrates a flowchart of a method that supports power reduction for signal transmission in accordance with aspects of the present disclosure.

FIG. 4 illustrates a flowchart of a method that supports power reduction for signal transmission in accordance with aspects of the present disclosure.

FIG. 5 illustrates a flowchart of a method that supports power reduction for signal transmission in accordance with aspects of the present disclosure.

### DETAILED DESCRIPTION

Implementations of power reduction for signal transmission are described, such as related to techniques that reduce an amount of power reduction that is applied as part of compliance with user safety parameters such as regulatory parameters for SAR, MPE, and so forth. For instance, an amount of power reduction that is applied is reduced for signal transmission by a UE over single carrier frequencies which can provide higher signal quality and increased device (e.g., UE) performance.

In some wireless communications systems transmit power of devices is increased to attempt to improve coverage. For instance, higher power classes have been defined that provide higher transmit power for UEs. However, with power classes that provide increased transmit power, a UE is still expected to meet regulatory parameters (e.g., Federal Communications Commission (FCC) regulations) for parameters such as SAR and MPE. Accordingly, different power class reduction values have been defined that can be applied for different power classes to reduce transmit power. However, some defined power class reduction values reduce transmit power more than is necessary to achieve specified user safety parameters. By reducing transmit power more than is necessary, some wireless communications systems may experience reduced signal quality and/or reduced overall UE performance.

Accordingly, in aspects of power reduction for signal transmission, power reduction is controlled to reduce an amount of power reduction that is applied as part of compliance with user safety parameters. For instance, an amount of power reduction that is applied is reduced which can provide higher signal quality and increased device (e.g., UE) performance. To avoid reducing power more than is necessary (e.g., as part of power class reduction and/or maximum configured power reduction), power class reduction algorithms are disclosed that provide minimum power class reductions for different power classes while enabling compliance with specified user safety parameters. Further, when power class reduction is applied, the described techniques enable appropriate MPR and A-MPR values to be identified and applied, such as when reduced power class values do not correspond to power classes for which MPR and/or A-MPR are defined. Thus, by minimizing power reduction applied at a device in conjunction with maintaining user safety, device performance such as transmission signal strength and/or signal quality is enhanced.

Aspects of the present disclosure are described in the context of a wireless communications system. Aspects of the present disclosure are further illustrated and described with reference to device diagrams and flowcharts that relate to power reduction for signal transmission.

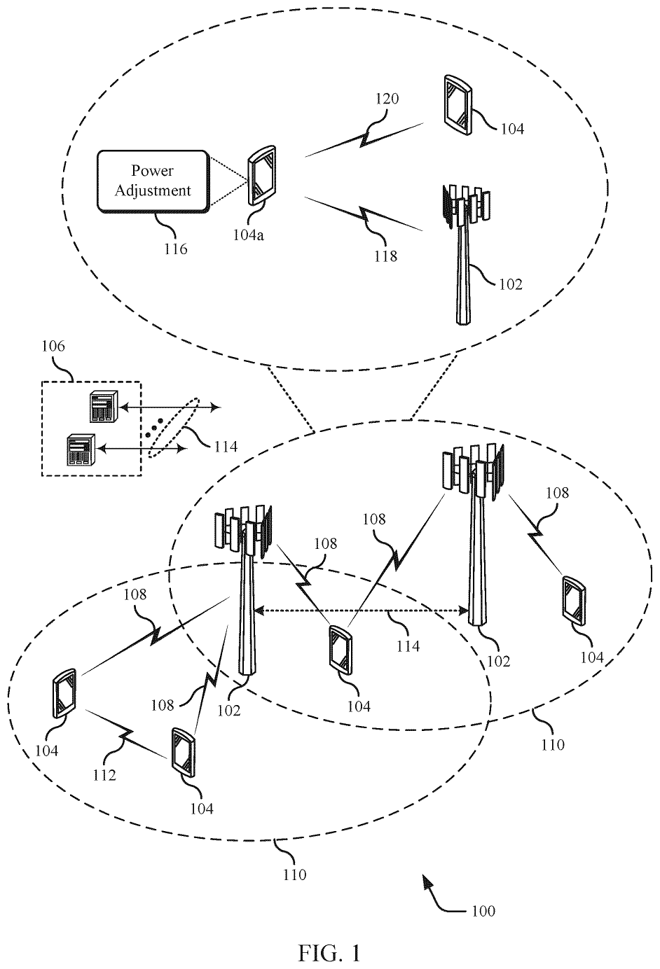

FIG. 1 illustrates an example of a wireless communications system 100 that supports power reduction for signal transmission in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of the UEs 104 are operable to implement various aspects of power reduction for signal transmission, as described herein. For instance, a UE 104a can implement power adjustment 116 operations to adjust power attributes of operation of the UE 104a, examples of which are detailed throughout this disclosure. The power adjustment 116, for example, adjusts power applied by the UE 104a as part of signal transmissions 118 to a base station 102 (e.g., uplink transmissions) and/or as part of signal transmissions 120 to other UEs 104, e.g., sidelink transmissions. The power adjustment 116, for example, enables to UE 104a to attempt to comply with transmission power parameters (e.g., SAR, MPE, etc.) as part of the signal transmissions 118, 120.

In some wireless communications systems there has been a trend of increasing the transmit power of devices to improve coverage. For instance, a default power class can be defined as 23 decibel-milliwatts (dBm) which corresponds to power class 3. Further, 26 dBm and 29 dB power classes have been introduced, which correspond to power classes 2 and 1.5, respectively. However, with power classes that provide increased transmit power, a UE is still expected to meet regulatory parameters (e.g., Federal Communications Commission (FCC) regulations) for parameters such as SAR and MPE.

There is an implicit assumption in 3GPP that Power Class 3 devices (23 dBm) can meet SAR and MPE regulations without mitigation. However, there is no guarantee that a Power Class 3 device will meet SAR and MPE without mitigation through power reduction. In some scenarios, power mitigation is utilized where a UE uses power management maximum power reduction (P-MPR) to reduce its power to meet regulatory parameters such as SAR and MPE. Further, some optional capabilities have been introduced to enable a UE to indicate to a gNB conditions under which it can meet regulatory requirements (including SAR and MPE) without power mitigation and conditions under which power mitigation may be implemented. Examples of these optional capabilities which have been introduced include:
i) maxUplinkDutyCycle-PC2-FR1
ii) maxUplinkDutyCycle-PC1dot5-MPE-FR1-r16
iii) maxUplinkDutyCycle-MPE-FR1

These capabilities for instance, can be as follows:
maxUplinkDutyCycle-PC2-FR1
Indicates the maximum percentage of symbols during a certain evaluation period that can be scheduled for uplink transmission to ensure compliance with applicable electromagnetic energy absorption requirements provided by regulatory bodies.
maxUplinkDutyCycle-PC1dot5-MPE-FR1-r16

Indicates the maximum percentage of symbols during a certain evaluation period that can be scheduled for uplink transmission to ensure compliance with applicable electromagnetic energy absorption requirements provided by regulatory bodies. In the discussion below, maxUplinkDutyCycle-MPE-FR1 can be assumed to be the same as maxUplinkDutyCycle-PC1dot5-MPE-FR1-r16. It appears that there may be an error in the current version of the specification where maxUplinkDutyCycle-MPE-FR1 has been incorrectly used in place of maxUplinkDutyCycle-PC1dot5-MPE-FR1-r16.

These optional parameters are used to set the value ΔP_{PowerClass} in the following equations in which a UE is allowed to set its configured maximum output power P_{CMAX,f,c} for carrier f of serving cell c in each slot (the following discussion references material from 3GPP technical specification (TS) 36.101-1 v17.5.0). The configured maximum output power P_{CMAX,f,c} is set within the following bounds:

$${P}_{CMAX \_ L , f , c} \leq {P}_{CMAX , f , c} \leq {P}_{CMAX \_ H , f , c} with$$

$${P}_{CMAX \_ L , f , c} = MIN \{ {P}_{EMAX , c} - Δ {T}_{C , c} , ( {P}_{PowerClass} - Δ {P}_{PowerClass} ) - MAX ( \text{} MAX ( {MPR}_{c} + Δ {MPR}_{c} , A - {MPR}_{c} ) + Δ {T}_{IB , c} + Δ {T}_{C , c} + Δ {T}_{RxSRS} , P - {MPR}_{c} ) \}$$

$${P}_{CMAX \_ H , f , c} = MIN \{ {P}_{EMAX , c} , {P}_{PowerClass} - Δ {P}_{PowerClass} \}$$

where
P_{EMAX,c} is the value given by either the p-Max IE or the field additionalPmax of the NR-NS-PmaxList IE, whichever is applicable according to TS 38.331 [7];
P_{PowerClass} is the maximum UE power specified in Table 6.2.1-1 without considering the tolerance specified in the Table 6.2.1-1;
When the IE powerBoostPi2BPSK is set to 1, P_{EMAX,c} is increased by +3 dB for a power class 3 capable UE operating in TDD bands n40, n41, n77, n78, and n79 with PI/2 BPSK modulation and UE indicates support for UE capability powerBoosting-pi2BPSK and 40% or less symbols in certain evaluation period are used for UL transmission when P_{EMAX,c}≥20 dBm (The exact evaluation period is no less than one radio frame).
When the IE powerBoostPi2BPSK is set to 1, ΔP_{PowerClass}=−3 dB for a power class 3 capable UE operating in TDD bands n40, n41, n77, n78, and n79 with Pi/2 BPSK modulation and UE indicates support for UE capability powerBoosting-pi2BPSK and 40% or less slots in radio frame are used for UL transmission.

### The Rules for Adjusting ΔP_{PowerClass} are Given by the Following:

ΔP_{PowerClass}=
   3 dB for a power class 2-capable UE or 6 dB for a power class 1.5-capable UE when P-max of 23 dBm or lower is indicated; or when the field of UE capability maxUplinkDutyCycle-PC2-FR1 is absent and the field of UE capability maxUplinkDutyCycle-MPE-FR1 is absent and the percentage of uplink symbols transmitted in a certain evaluation period is larger than 50%; or when the field of UE capability maxUplinkDutyCycle-PC2-FR1 is not absent and the percentage of uplink symbols transmitted in a certain evaluation period is larger than maxUplinkDutyCycle-PC2-FR1 as defined in TS 38.306 (e.g., the exact evaluation period is no less than one radio frame); or when the field of UE capability maxUplinkDutyCycle-MPE-FR1 is not absent and half the percentage of uplink symbols transmitted in a certain evaluation period is larger than maxUplinkDutyCycle-MPE-FR1 as defined in TS 38.306, e.g., the exact evaluation period is no less than one radio frame).
3 dB for a power class 1.5-capable UE when P-max of between 23 dBm and 26 dB is indicated; or when the field of UE capability maxUplinkDutyCycle-PC2-FR1 is absent and the field of UE capability maxUplinkDutyCycle-MPE-FR1 is absent and the percentage of uplink symbols transmitted in a certain evaluation period is between 25% and 50%; or when the field of UE capability maxUplinkDutyCycle-PC2-FR1 is not absent and the percentage of uplink symbols transmitted in a certain evaluation period is between maxUplinkDutyCycle-PC2-FR1 and maxUplinkDutyCycle-PC2-FR1/2 as defined in TS 38.306, e.g., the exact evaluation period is no less than one radio frame; or when the field of UE capability maxUplinkDutyCycle-MPE-FR1 is not absent and the percentage of uplink symbols transmitted in a certain evaluation period is larger than maxUplinkDutyCycle-MPE-FR1 as defined in TS 38.306, e.g., the exact evaluation period is no less than one radio frame.
3 dB when the UE is configured with SUL configurations and the requirements of default power class are applied as specified in sub-clause 6.2C.1 on the band where UE indicates power class 2;
0 dB otherwise;

### Accordingly, the Following Observations can be Made:

i) If neither of the optional capabilities is signalled, then.
   If the percentage of uplink symbols transmitted in the evaluation period is greater than 50%, then P_{PowerClass}−ΔP_{PowerClass}=23 dBm.
   If the percentage of uplink symbols transmitted in the evaluation period is greater than 25% but less than 50%, then P_{PowerClass}−ΔP_{PowerClass}=26 dBm for both P_{PowerClass}=29 dBm and P_{PowerClass}=26 dBm.
   If the percentage of uplink symbols transmitted in the evaluation period is less than 25%, then P_{PowerClass}−ΔP_{PowerClass}=29 dBm for P_{PowerClass}=29 dBm, and P_{PowerClass}−ΔP_{PowerClass}=26 dBm for P_{PowerClass}=29 dBm.
ii) If maxUplinkDutyCycle-PC2-FR1 is signalled, then
   If the percentage of uplink symbols transmitted in the evaluation period is greater than maxUplinkDutyCycle-PC2-FR1, then P_{PowerClass}−ΔP_{PowerClass}=23 dBm.
   If the percentage of uplink symbols transmitted in the evaluation period is greater than maxUplinkDutyCycle-PC2-FR1/2 but less than maxUplinkDutyCycle-PC2-FR1, then P_{PowerClass}−ΔP_{PowerClass}=26 dBm for both P_{PowerClass}=29 dBm and P_{PowerClass}=26 dBm.
   If the percentage of uplink symbols transmitted in the evaluation period is less than maxUplinkDutyCycle-PC2-FR1/2, then P_{PowerClass}−ΔP_{PowerClass}=29 dBm for P_{PowerClass}=29 dBm, and P_{PowerClass}−ΔP_{PowerClass}=26 dBm for P_{PowerClass}=29 dBm.
iii) If maxUplinkDutyCycle-PC2-FR1 is absent and maxUplinkDutyCycle-MPE-FR1 is signalled, then.
   If the 0.5*the percentage of uplink symbols transmitted in the evaluation period is greater than maxUplinkDutyCycle-MPE-FR1, then P_{PowerClass}−ΔP_{PowerClass}=23 dBm.
   If the percentage of uplink symbols transmitted in the evaluation period is greater than maxUplinkDutyCycle-MPE-FR1 but less than maxUplinkDutyCycle-MPE-FR1*2, then P_{PowerClass}−ΔP_{PowerClass}=26 dBm for both P_{PowerClass}=29 dBm and P_{PowerClass}=26 dBm.
   If the percentage of uplink symbols transmitted in the evaluation period is less than maxUplinkDutyCycle-MPE-FR1/2, then P_{PowerClass}−ΔP_{PowerClass}=29 dBm for P_{PowerClass}=29 dBm, and P_{PowerClass}−ΔP_{PowerClass}=26 dBm for P_{PowerClass}=29 dBm.

There is a drawback to the approach taken in some wireless communications systems (e.g., as specified in the current TS) in that the maximum power is reduced more than is necessary. For example, in the case that the optional capabilities are not signalled and the percentage of symbols transmitted in the evaluation period is 55%, a power class 2 device may reduce its maximum power by 3 dB even though the power reduction needed to meet SAR and/or MPE is only

$$10 * log 10 ( \frac{0.55}{0.5} ) = 0.4 dB .$$

As a result, the power is reduced by 2.6 dB more than is necessary to meet regulatory requirements. Similarly, the power class 1.5 device may reduce its power by 6 dB, even though the power reduction needed to meet SAR and/or MPE is only

$$10 * log 10 ( \frac{0.55}{0.25} ) = 3.4 dB .$$

As indicated, the power is reduced by 2.6 dB more than is necessary to meet regulatory requirements.

Accordingly, in aspects of power reduction for signal transmission, power reduction is controlled to reduce an amount of power reduction that is applied as part of compliance with user safety parameters, such as regulatory parameters for SAR, MPE, and so forth. For instance, an amount of power reduction that is applied is reduced which can provide higher signal quality and increased device (e.g., UE) performance.

For instance, to avoid reducing power more than is necessary (e.g., as part of power class reduction and/or maximum configured power reduction), ΔP_{PowerClass} can be selected so that the value of P_{PowerClass}−ΔP_{PowerClass} is approximately equal to the maximum power that can be transmitted while still meeting transmission parameters, e.g., SAR and/or MPE parameters. If optional capabilities are not signalled, for example, and a percentage of symbols transmitted in an evaluation period is 55%, the value of ΔP_{PowerClass} can be 0.4 dB for the power class 2 device and 3.4 dB for the power class 1.5 device. In implementations, where the optional capabilities are not specified (e.g., signalled), the value of ΔP_{PowerClass} can be given by:

$$Δ {P}_{PowerClass} = \{ \begin{matrix}max \{ 10 * log 10 ( \frac{x}{0.25} ) , 0 \} & Δ {P}_{PowerClass} = 29 dBm \\ max \{ 10 * log 10 ( \frac{x}{0.5} ) , 0 \} & Δ {P}_{PowerClass} = 26 dBm\end{matrix}$$

where x is the percentage of symbols transmitted in the evaluation period.

Further, power reduction parameters can be specified for scenarios where optional capabilities are specified, e.g., signalled. For example, where maxUplinkDutyCycle-PC2-FR1 is specified, the value of ΔP_{PowerClass} can be given by:

$$Δ {P}_{PowerClass} = \{ \begin{matrix}max \{ 10 * log 10 ( \frac{2 x}{\begin{matrix}max UplinkDutyCycle - \\ PC 2 - FR 1\end{matrix}} ) , 0 \} & {P}_{PowerClass} = 29 dBm \\ max \{ 10 * log 10 ( \frac{x}{\begin{matrix}max UplinkDutyCycle - \\ PC 2 - FR 1\end{matrix}} ) , 0 \} & {P}_{PowerClass} = 26 dBm\end{matrix}$$

Alternatively, in order to limit the power class reduction ΔP_{PowerClass} in the case that maxUplinkDutyCycle-PC2-FR1 is less than 0.5, the following modification can be used

$$Δ {P}_{PowerClass} = \{ \begin{matrix}min \{ max \{ 10 * log 10 ( \frac{2 x}{\begin{matrix}max UplinkDutyCycle - PC 2 - FR 1\end{matrix}} ) , 0 \} , 6 \} & {P}_{PowerClass} = 29 dBm \\ min \{ max \{ 10 * log 10 ( \frac{x}{\begin{matrix}max UplinkDutyCycle - PC 2 - FR 1\end{matrix}} ) , 0 \} , 3 \} & {P}_{PowerClass} = 26 dBm\end{matrix}$$

In scenarios where maxUplinkDutyCycle-PC2-FR1 is absent and maxUplinkDutyCycle-MPE-FR1 is signaled, the value of ΔP_{PowerClass} can be given by:

$$Δ {P}_{PowerClass} = \{ \begin{matrix}max \{ 10 * log 10 ( \frac{x}{\begin{matrix}max UplinkDutyCycle - \\ MPE - FR 1\end{matrix}} ) , 0 \} & {P}_{PowerClass} = 29 dBm \\ max \{ 10 * log 10 ( \frac{0.5 x}{\begin{matrix}max UplinkDutyCycle - \\ MPE - FR 1\end{matrix}} ) , 0 \} & {P}_{PowerClass} = 26 dBm\end{matrix}$$

Alternatively, in order to limit the power class reduction ΔP_{PowerClass} in the case that maxUplinkDutyCycle-MPE-FR1 is less than 0.25, the following modification can be used

$$Δ {P}_{PowerClass} = \{ \begin{matrix}min \{ max \{ 10 * log 10 ( \frac{x}{\begin{matrix}max UplinkDutyCycle - MPE - FR 1\end{matrix}} ) , 0 \} , 6 \} & {P}_{PowerClass} = 29 dBm \\ min \{ max \{ 10 * log 10 ( \frac{0.5 x}{\begin{matrix}max UplinkDutyCycle - MPE - FR 1\end{matrix}} ) , 0 \} , 3 \} & {P}_{PowerClass} = 26 dBm\end{matrix}$$

In applying the implementations and equations specified above, the values for ΔP_{PowerClass} can be applied in the configured maximum power equations:

$${P}_{CMAX \_ L , f , c} \leq {P}_{CMAX , f , c} \leq {P}_{CMAX \_ H , f , c} with$$

$${P}_{CMAX \_ L , f , c} = MIN \{ {P}_{EMAX , c} - Δ {T}_{C , c} , ( {P}_{PowerClass} - Δ {P}_{PowerClass} ) - MAX ( \text{} MAX ( {MPR}_{c} + Δ {MPR}_{c} , A - {MPR}_{c} ) + Δ {T}_{IB , c} + Δ {T}_{C , c} + Δ {T}_{RxSRS} , P - {MPR}_{c} ) \}$$

$${P}_{CMAX \_ H , f , c} = MIN \{ {P}_{EMAX , c} , {P}_{PowerClass} - Δ {P}_{PowerClass} \} ,$$

In some scenarios, MPR and A-MPR values are not defined for all values of P_{PowerClass}−ΔP_{PowerClass}. For example, MPR and A-MPR values can be specified for defined values of P_{PowerClass} such as 23 dBm, 26 dBm, 29 dBm, etc. Thus, according to implementations described herein, the MPR and/or A-MPR that is used can be the MPR and/or A-MPR that is defined for P_{PowerClass} and not for P_{PowerClass}-ΔP_{PowerClass}, for which MPR and/or A-MPR may not be explicitly defined. Further, when P_{PowerClass}−ΔP_{PowerClass} falls below a value of a lower power class for which MPR and/or A-MPR is defined, the MPR and/or A-MPR for this lower power class may be used. For example, if P_{PowerClass}=29 dBm and P_{PowerClass}−ΔP_{PowerClass}=24.5 dBm, then the MPR and/or A-MPR defined for 26 dBm may be used.

Accordingly, implementations can reduce ΔP_{PowerClass} which can be defined as
ΔP_{PowerClass} Adjustment to maximum output power for a given power class.
   to a minimum that is needed to meet parameters such as SAR and MPE. For instance, implementations redefine ΔP_{PowerClass}, to a value that is less than or equal to values utilized in some wireless communications systems. Thus, ΔP_{PowerClass} can be used to define upper and lower bounds on P_{CMAX,f,c}.
P_{CMAX,f,c} A configured maximum UE output power for carrier f of serving cell c in each slot.

Accordingly, in implementations a UE is to set its value of P_{CMAX,f,c} between the upper and lower bounds of P_{CMAX_H,f,c} and P_{CMAX_L,f,c}. The UE is then able to transmit P_{CMAX,f,c} power when it is power controlled up to its maximum power. Thus, by reducing ΔP_{PowerClass}, implementations can increase both P_{CMAX_H,f,c} and P_{CMAX_L,f,c} and thus enable a UE to increase its configured maximum power represented by P_{CMAX,f,c}.

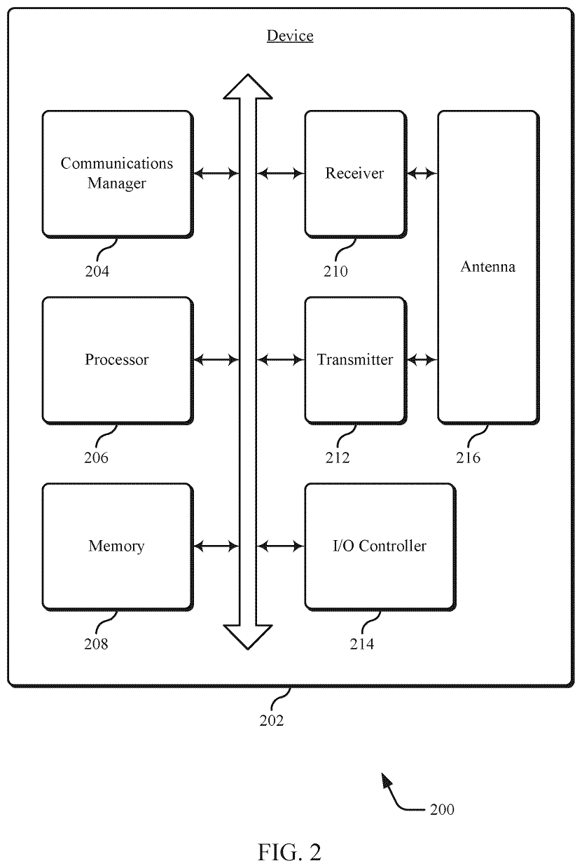

FIG. 2 illustrates an example of a block diagram 200 of a device 202 that supports power reduction for signal transmission in accordance with aspects of the present disclosure. The device 202 may be an example of a UE 104 as described herein. The device 202 may support wireless communication and/or network signaling with one or more base stations 102, other UEs 104, network entities and devices, or any combination thereof. The device 202 may include components for bi-directional communications including components for transmitting and receiving communications, such as a communications manager 204, a processor 206, a memory 208, a receiver 210, a transmitter 212, and an I/O controller 214. These components may be in electronic communication or otherwise coupled (e.g., operatively, communicatively, functionally, electronically, electrically) via one or more interfaces (e.g., buses).

The communications manager 204, the receiver 210, the transmitter 212, or various combinations thereof or various components thereof may be examples of means for performing various aspects of the present disclosure as described herein. For example, the communications manager 204, the receiver 210, the transmitter 212, or various combinations or components thereof may support a method for performing one or more of the functions described herein.

In some implementations, the communications manager 204, the receiver 210, the transmitter 212, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 206 and the memory 208 coupled with the processor 206 may be configured to perform one or more of the functions described herein (e.g., by executing, by the processor 206, instructions stored in the memory 208).

Additionally or alternatively, in some implementations, the communications manager 204, the receiver 210, the transmitter 212, or various combinations or components thereof may be implemented in code (e.g., as communications management software or firmware) executed by the processor 206. If implemented in code executed by the processor 206, the functions of the communications manager 204, the receiver 210, the transmitter 212, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 204 may be configured to perform various operations (e.g., receiving, monitoring, transmitting) using or otherwise in cooperation with the receiver 210, the transmitter 212, or both. For example, the communications manager 204 may receive information from the receiver 210, send information to the transmitter 212, or be integrated in combination with the receiver 210, the transmitter 212, or both to receive information, transmit information, or perform various other operations as described herein. Although the communications manager 204 is illustrated as a separate component, in some implementations, one or more functions described with reference to the communications manager 204 may be supported by or performed by the processor 206, the memory 208, or any combination thereof. For example, the memory 208 may store code, which may include instructions executable by the processor 206 to cause the device 202 to perform various aspects of the present disclosure as described herein, or the processor 206 and the memory 208 may be otherwise configured to perform or support such operations.

For example, the communications manager 204 may support wireless communication and/or network signaling at a device (e.g., the device 202, a UE) in accordance with examples as disclosed herein. The communications manager 204 and/or other device components may be configured as or otherwise support an apparatus, such as a UE, including a transceiver; a processor coupled to the transceiver, the processor and the transceiver configured to cause the apparatus to: detect a condition to adjust a power class reduction for a single carrier transmission; and adjust the power class reduction for the single carrier transmission based on a measured duty cycle and a maximum duty cycle.

Additionally, the apparatus (e.g., a UE) includes any one or combination of: where the processor and the transceiver are configured to cause the UE to adjust the power class reduction for single carrier transmission based on a ratio of the measured duty cycle and the maximum duty cycle; where based at least in part on adjustment of the power class reduction for single carrier transmission, the processor and the transceiver are configured to cause the UE to adjust an upper bound of a transmitter power; where based at least in part on adjustment of the power class reduction for single carrier transmission, the processor and the transceiver are configured to cause the UE to adjust a lower bound of a transmitter power; where to adjust the power class reduction, the transceiver are configured to cause the UE to reduce the power class reduction for single carrier transmission based on the measured duty cycle and the maximum duty cycle; where the measured duty cycle includes a percentage of symbols transmitted by the UE over an evaluation period; where the processor and the transceiver are configured to cause the UE to determine a value for the maximum duty cycle based on a power class of the UE; where the processor and the transceiver are configured to cause the UE to: determine that an adjusted power class does not correspond to a power class for which MPR or A-MPR is defined; and utilize an MPR or A-MPR for a next higher power class for which MPR or A-MPR is defined for single carrier transmission by the UE.

The communications manager 204 and/or other device components may be configured as or otherwise support a means for wireless communication and/or network signaling at a UE, including detecting a condition to adjust a power class reduction for single carrier transmission by a UE; and adjusting the power class reduction for the single carrier transmission based on a measured duty cycle and a maximum duty cycle.

Additionally, wireless communication and/or network signaling at the UE includes any one or combination of: adjusting the power class reduction for single carrier transmission based on a ratio of the measured duty cycle and the maximum duty cycle; based at least in part on adjustment of the power class reduction for single carrier transmission, adjusting an upper bound of a transmitter power; based at least in part on adjustment of the power class reduction for single carrier transmission, adjusting a lower bound of a transmitter power; where based at least in part on adjustment of the power class reduction for single carrier transmission, adjusting the power class reduction includes reducing the power class reduction for single carrier transmission based on the measured duty cycle and the maximum duty cycle where the measured duty cycle includes a percentage of symbols transmitted by the UE over an evaluation period determining a value for the maximum duty cycle based on a power class of the UE further including: determining that an adjusted power class does not correspond to a power class for which MPR or A-MPR is defined; and utilizing an MPR or A-MPR for a next higher power class for which MPR or A-MPR is defined for single carrier transmission by the UE

The communications manager 204 and/or other device components may be configured as or otherwise support an apparatus, such as a UE, including a transceiver; a processor coupled to the transceiver, the processor and the transceiver configured to cause the apparatus to: detect a condition to adjust a power class reduction for single carrier transmission; and adjust the power class reduction for the single carrier transmission based on a measured duty cycle and a defined maximum power class duty cycle.

Additionally, the apparatus (e.g., a UE) includes any one or combination of: where the processor and the transceiver are configured to cause the UE to adjust the power class reduction for single carrier transmission based on a ratio of the measured duty cycle and the defined maximum power class duty cycle; where based at least in part on adjustment of the power class reduction for single carrier transmission, the processor and the transceiver are configured to cause the UE to adjust an upper bound of a transmitter power; where based at least in part on adjustment of the power class reduction for single carrier transmission, the processor and the transceiver are configured to cause the UE to adjust a lower bound of a transmitter power; where the processor and the transceiver are configured to cause the UE to reduce the power class reduction for single carrier transmission based on the measured duty cycle and the defined maximum power class duty cycle; where the measured duty cycle includes a percentage of symbols transmitted by the UE over an evaluation period; where the defined maximum power class duty cycle is based on one or more of a UE type or a UE power class; where the processor and the transceiver are configured to cause the UE to: determine that an adjusted power class does not correspond to a power class for which MPR or A-MPR is defined; and utilize an MPR or A-MPR for a next higher power class for which MPR or A-MPR is defined for single carrier transmission by the UE;

The communications manager 204 and/or other device components may be configured as or otherwise support a means for wireless communication and/or network signaling at a UE, including detecting a condition to adjust a power class reduction for single carrier transmission by a UE; and adjusting the power class reduction for the single carrier transmission based on a measured duty cycle and a defined maximum power class duty cycle.

Additionally, wireless communication and/or network signaling at the UE includes any one or combination of: adjusting the power class reduction for single carrier transmission based on a ratio of the measured duty cycle and the defined maximum power class duty cycle; based at least in part on adjustment of the power class reduction for single carrier transmission, adjusting an upper bound of a transmitter power; based at least in part on adjustment of the power class reduction for single carrier transmission, adjusting a lower bound of a transmitter power; reducing the power class reduction for single carrier transmission based on the measured duty cycle and the defined maximum power class duty cycle where the measured duty cycle includes a percentage of symbols transmitted by the UE over an evaluation period where the defined maximum power class duty cycle is based on one or more of a UE type or a UE power class further including: determining that an adjusted power class does not correspond to a power class for which MPR or A-MPR is defined; and utilizing an MPR or A-MPR for a next higher power class for which MPR or A-MPR is defined for single carrier transmission by the UE

The communications manager 204 and/or other device components may be configured as or otherwise support an apparatus, such as a UE, including a transceiver; a processor coupled to the transceiver, the processor and the transceiver configured to cause the apparatus to: detect a condition to adjust a power class reduction for single carrier transmission; adjust the power class reduction for the single carrier transmission based on one or more of a measured duty cycle and a maximum duty cycle, or a measured duty cycle and a defined maximum power class duty cycle; determine that an adjusted power class does not correspond to a power class for which MPR or A-MPR is defined; and utilize an MPR or A-MPR for a next higher power class for which MPR or A-MPR is defined for single carrier transmission by the UE.

Additionally, the apparatus (e.g., a UE) includes any one or combination of: where the processor and the transceiver are configured to cause the UE to adjust the power class reduction for single carrier transmission based on one or more of: a ratio of the measured duty cycle and the maximum duty cycle; or a ratio of the measured duty cycle and the defined maximum power class duty cycle; where based at least in part on adjustment of the power class reduction for single carrier transmission, the processor and the transceiver are configured to cause the UE to adjust a bound of a transmitter power, and where the bound on transmitter power is one or more of: an upper bound on the transmitter power; or a lower bound on the transmitter power; where the measured duty cycle includes a percentage of symbols transmitted by the UE over an evaluation period

The communications manager 204 and/or other device components may be configured as or otherwise support a means for wireless communication and/or network signaling at a UE, including detecting a condition to adjust a power class reduction for single carrier transmission by a UE; adjusting the power class reduction for the single carrier transmission based on one or more of a measured duty cycle and a maximum duty cycle, or a measured duty cycle and a defined maximum power class duty cycle; determining that an adjusted power class does not correspond to a power class for which MPR or A-MPR is defined; and utilizing an MPR or A-MPR for a next higher power class for which MPR or A-MPR is defined for single carrier transmission by the UE

Additionally, wireless communication and/or network signaling at the UE includes any one or combination of: where adjusting the power class reduction for single carrier transmission is based on one or more of: a ratio of the measured duty cycle and the maximum duty cycle; or a ratio of the measured duty cycle and the defined maximum power class duty cycle; based at least in part on adjustment of the power class reduction for single carrier transmission, adjusting a bound of a transmitter power, and where the bound on the transmitter power is one or more of: an upper bound on the transmitter power; or a lower bound on the transmitter power where the measured duty cycle includes a percentage of symbols transmitted by the UE over an evaluation period.

The processor 206 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 206 may be configured to operate a memory array using a memory controller. In some other implementations, a memory controller may be integrated into the processor 206. The processor 206 may be configured to execute computer-readable instructions stored in a memory (e.g., the memory 208) to cause the device 202 to perform various functions of the present disclosure.

The memory 208 may include random access memory (RAM) and read-only memory (ROM). The memory 208 may store computer-readable, computer-executable code including instructions that, when executed by the processor 206 cause the device 202 to perform various functions described herein. The code may be stored in a non-transitory computer-readable medium such as system memory or another type of memory. In some implementations, the code may not be directly executable by the processor 206 but may cause a computer (e.g., when compiled and executed) to perform functions described herein. In some implementations, the memory 208 may include, among other things, a basic I/O system (BIOS) which may control basic hardware or software operation such as the interaction with peripheral components or devices.

The I/O controller 214 may manage input and output signals for the device 202. The I/O controller 214 may also manage peripherals not integrated into the device 202. In some implementations, the I/O controller 214 may represent a physical connection or port to an external peripheral. In some implementations, the I/O controller 214 may utilize an operating system such as iOS®, ANDROID®, MS-DOS®, MS-WINDOWS®, OS/2®, UNIX®, LINUX®, or another known operating system. In some implementations, the I/O controller 214 may be implemented as part of a processor, such as the processor 206. In some implementations, a user may interact with the device 202 via the I/O controller 214 or via hardware components controlled by the I/O controller 214.

In some implementations, the device 202 may include a single antenna 216. However, in some other implementations, the device 202 may have more than one antenna 216, which may be capable of concurrently transmitting or receiving multiple wireless transmissions. The receiver 210 and the transmitter 212 may communicate bi-directionally, via the one or more antennas 216, wired, or wireless links as described herein. For example, the receiver 210 and the transmitter 212 may represent a wireless transceiver and may communicate bi-directionally with another wireless transceiver. The transceiver may also include a modem to modulate the packets, to provide the modulated packets to one or more antennas 216 for transmission, and to demodulate packets received from the one or more antennas 216.

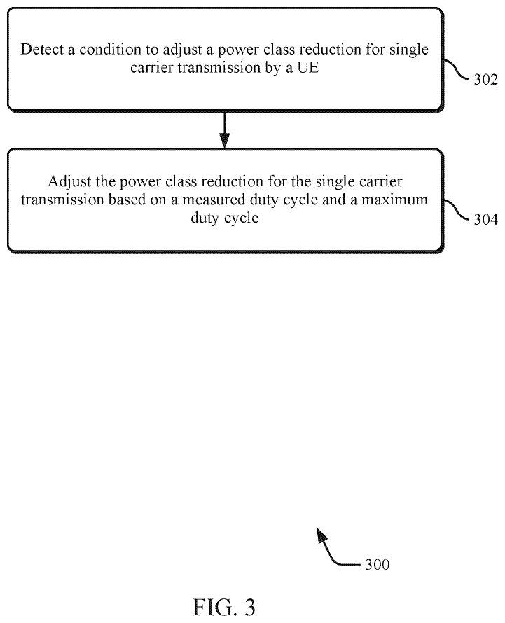

FIG. 3 illustrates a flowchart of a method 300 that supports power reduction for signal transmission in accordance with aspects of the present disclosure. The operations of the method 300 may be implemented and performed by a device or its components, such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 302, the method may include detecting a condition to adjust a power class reduction for single carrier transmission by a UE. The operations of 302 may be performed in accordance with examples as described herein. In some implementations, aspects of the operations of 302 may be performed by a device as described with reference to FIG. 1.

At 304, the method may include adjusting the power class reduction for the single carrier transmission based on a measured duty cycle and a maximum duty cycle. The operations of 304 may be performed in accordance with examples as described herein. In some implementations, aspects of the operations of 304 may be performed by a device as described with reference to FIG. 1.

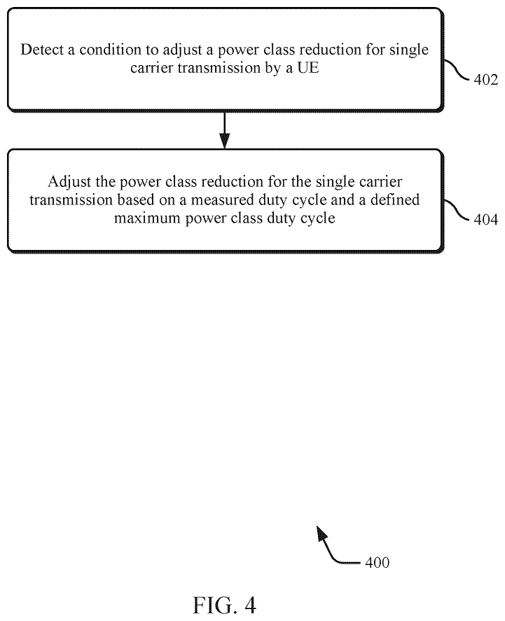

FIG. 4 illustrates a flowchart of a method 400 that supports power reduction for signal transmission in accordance with aspects of the present disclosure. The operations of the method 400 may be implemented and performed by a device or its components, such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 402, the method may include detecting a condition to adjust a power class reduction for single carrier transmission by a UE. The operations of 402 may be performed in accordance with examples as described herein. In some implementations, aspects of the operations of 402 may be performed by a device as described with reference to FIG. 1.

At 404, the method may include adjusting the power class reduction for the single carrier transmission based on a measured duty cycle and a defined maximum power class duty cycle. The operations of 404 may be performed in accordance with examples as described herein. In some implementations, aspects of the operations of 404 may be performed by a device as described with reference to FIG. 1.

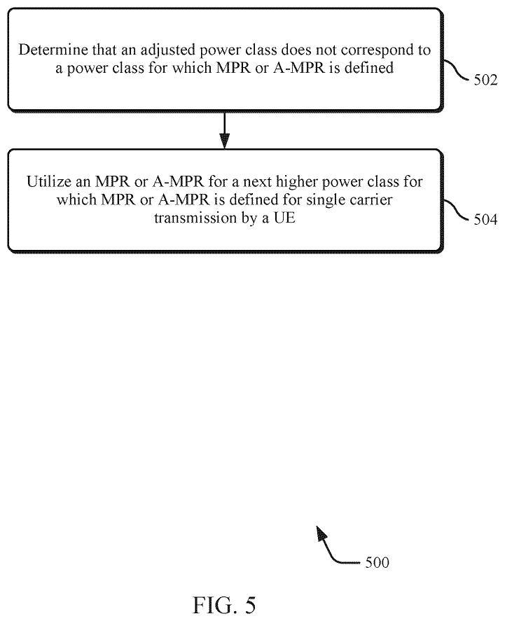

FIG. 5 illustrates a flowchart of a method 500 that supports power reduction for signal transmission in accordance with aspects of the present disclosure. The operations of the method 500 may be implemented and performed by a device or its components, such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 502, the method may include determining that an adjusted power class does not correspond to a power class for which MPR or A-MPR is defined. The operations of 502 may be performed in accordance with examples as described herein. In some implementations, aspects of the operations of 502 may be performed by a device as described with reference to FIG. 1.

At 504, the method may include utilizing an MPR or A-MPR for a next higher power class for which MPR or A-MPR is defined for single carrier transmission by a UE. The operations of 504 may be performed in accordance with examples as described herein. In some implementations, aspects of the operations of 504 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
detect a condition to adjust a power class reduction for a single carrier transmission; and
adjust the power class reduction for the single carrier transmission based on a measured duty cycle and a maximum duty cycle.

2. The UE of claim 1, wherein the at least one processor is configured to cause the UE to adjust the power class reduction for single carrier transmission based at least in part on a ratio of the measured duty cycle and the maximum duty cycle.

3. The UE of claim 1, wherein based at least in part on adjustment of the power class reduction for single carrier transmission, the at least one processor is configured to cause the UE to adjust an upper bound of a transmitter power.

4. The UE of claim 1, wherein based at least in part on adjustment of the power class reduction for single carrier transmission, the at least one processor is configured to cause the UE to adjust a lower bound of a transmitter power.

5. The UE of claim 1, wherein to adjust the power class reduction, the at least one processor is configured to cause the UE to reduce the power class reduction for single carrier transmission based at least in part on the measured duty cycle and the maximum duty cycle.

6. The UE of claim 1, wherein the measured duty cycle comprises a percentage of symbols transmitted by the UE over an evaluation period.

7. The UE of claim 1, wherein the at least one processor is configured to cause the UE to determine a value for the maximum duty cycle based at least in part on a power class of the UE.

8. The UE of claim 1, wherein the at least one processor is configured to cause the UE to:
determine that an adjusted power class does not correspond to a power class for which maximum power reduction (MPR) or additional maximum power reduction (A-MPR) is defined; and
utilize an MPR or A-MPR for a next higher power class for which MPR or A-MPR is defined for single carrier transmission by the UE.

9. A user equipment (UE) for wireless communication, comprising:
at least one memory; and
at least one processor coupled with the at least one memory and configured to cause the UE to:
detect a condition to adjust a power class reduction for single carrier transmission; and
adjust the power class reduction for the single carrier transmission based on a measured duty cycle and a defined maximum power class duty cycle.

10. The UE of claim 9, wherein the at least one processor is configured to cause the UE to adjust the power class reduction for single carrier transmission based at least in part on a ratio of the measured duty cycle and the defined maximum power class duty cycle.

11. The UE of claim 9, wherein based at least in part on adjustment of the power class reduction for single carrier transmission, the at least one processor is configured to cause the UE to adjust an upper bound of a transmitter power.

12. The UE of claim 9, wherein based at least in part on adjustment of the power class reduction for single carrier transmission, the at least one processor is configured to cause the UE to adjust a lower bound of a transmitter power.

13. The UE of claim 9, wherein the at least one processor is configured to cause the UE to reduce the power class reduction for single carrier transmission based at least in part on the measured duty cycle and the defined maximum power class duty cycle.

14. The UE of claim 9, wherein the measured duty cycle comprises a percentage of symbols transmitted by the UE over an evaluation period.

15. The UE of claim 9, wherein the defined maximum power class duty cycle comprises a defined maximum power class duty cycle defined based on one or more of a UE type or a UE power class.

16. The UE of claim 9, wherein the at least one processor is configured to cause the UE to:
determine that an adjusted power class does not correspond to a power class for which maximum power reduction (MPR) or additional maximum power reduction (A-MPR) is defined; and
utilize an MPR or A-MPR for a next higher power class for which MPR or A-MPR is defined for single carrier transmission by the UE.

17. A user equipment (UE) for wireless communication, comprising:
at least one memory; and
at least one processor coupled with the at least one memory and configured to cause the UE to:
detect a condition to adjust a power class reduction for single carrier transmission;
adjust the power class reduction for the single carrier transmission based on one or more of a measured duty cycle and a maximum duty cycle, or a measured duty cycle and a defined maximum power class duty cycle;
determine that an adjusted power class does not correspond to a power class for which maximum power reduction (MPR) or additional maximum power reduction (A-MPR) is defined; and
utilize an MPR or A-MPR for a next higher power class for which MPR or A-MPR is defined for single carrier transmission by the UE.

18. The UE of claim 17, wherein the at least one processor is configured to cause the UE to adjust the power class reduction for single carrier transmission based at least in part on one or more of:
a ratio of the measured duty cycle and the maximum duty cycle; or
a ratio of the measured duty cycle and the defined maximum power class duty cycle.

19. The UE of claim 17, wherein based at least in part on adjustment of the power class reduction for single carrier transmission, the at least one processor is configured to cause the UE to adjust a bound of a transmitter power, and wherein the bound on the transmitter power is one or more of:
an upper bound on the transmitter power; or
a lower bound on the transmitter power.

20. (canceled)

21. A processor for wireless communication, comprising:
at least one controller coupled with at least one memory and configured to cause the processor to:
detect a condition to adjust a power class reduction for a single carrier transmission; and
adjust the power class reduction for the single carrier transmission based on a measured duty cycle and a maximum duty cycle.
